(19) United States
(12) Patent Application Publication
(10) Pub. No.: US 2008/0300144 A1
(43) Pub. Date: Dec. 4, 2008

(54) Sensor for Biomolecules and a Method for Preparing and Using the Same

(75) Inventors: Johannes Bacher, Leonberg (DE); Andreas Boos, Bondorf (DE); Gerd Luedke, Holzgerlingen (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 12/158,082

(22) PCT Filed: Dec. 13, 2006
(86) PCT No.: PCT/IB2006/054792

§ 371 Date: Jun. 19, 2008

(30) Foreign Application Priority Data
Dec. 21, 2005 (EP) 05112550.8

(51) Int. Cl. C40B 30/04; C40B 60/12

(52) U.S. Cl. 506/9; 506/39

(57) ABSTRACT

Disclosed is a method of preparing a sensor for the analysis of a sample fluid, said sample fluid containing one or more target molecules. The method comprises the steps of applying a non-activated porous organic polymer membrane with probes in the form of an array of probe locations, said probes being able to specifically bind to said one or more target molecules. Furthermore, the method comprises the steps of blocking areas remaining free of probes of said porous organic polymer membrane with one or more blocking substances and forcing the sample fluid repeatedly in one or two directions through the pores of said porous organic polymer membrane. Also disclosed is a sensor for the analysis of a sample fluid.

The present invention relates to a method for performing fast and highly specific microarray assays by flowing one or more times a biological sample containing target molecules through a porous organic polymer membrane. In particular, the invention relates to an improved, inexpensive and efficient method for performing a microarray assay. Such microarray assays are useful as analytical methods in the fields of human and veterinary medicine, among others. In particular, the method can be used for molecular diagnostic tests for measuring the presence of infectious disease pathogens and resistance genes.

The presence and concentration of specific target molecules such as, but not limited to, proteins, DNA or RNA molecules, in a biological sample containing one or more other molecules can be determined by using the complex binding of these target molecules with probes. In the case of the traditional Western/Southern/Northern Blot, the target molecule is immobilized on the blot surface and subsequently detected by a soluble probe. For ELISA (enzyme-linked immunosorbent assay) or microarray based tests, the probes are immobilized instead. In the microarray technique, specific probes, each of which being chosen in order to interact specifically with one particular target molecule, are immobilized at specific locations of a solid surface. On the other hand, the target molecules are labeled by a detectable label molecule (e.g. a fluorophore or a magnetic bead). By contacting said solid surface with the biological sample, the target molecules are fixed at the locations corresponding to their specific probes. The detection of the target molecules and the measurement of their concentration in the biological sample are then operated respectively via the localization and the measurement of the intensity of the signals produced by the detectable labels bound to the target molecules. Due to the planar surface of standard microarrays, molecule transport within the biological sample is mostly governed by diffusion laws. As these arrays have a considerable surface area, several hours of hybridization time may be required to obtain sufficient binding. The diffusion limitation effect can be somewhat reduced by agitation or surface acoustic waves. However, due to the need to use smaller and smaller biological sample volumes and the resulting thin layer of liquid on top of the membrane, the efficiency of such agitation is low and does not allow turbulent mixture directly on the surface. In addition, standard microarrays require a washing step to remove this residual fluid layer from the top of the array prior to a measurement. This effectively limits or eliminates the possibility to use such a microarray for kinetic measurements where a series of consecutive measurements at different time points (to improve dynamic range of measurement) and/or temperature (to improve specificity by reducing the impact of unspecific binding) provides valuable additional information.

An improvement to the method described above is disclosed in WO/03004162 where an FTC (Flow Through Chip), i.e. a membrane containing first and second sides or surfaces, having a multiplicity of discrete channels extending through the membrane from the first side to the second side, is arrayed with distinct oligonucleotide DNA probes and is hybridized to a biological sample pool of distinct complementary DNA targets. The targets are modified with a fluorescein isothiocyanate fluorescent reporter group to permit direct detection on the chip. As the biological sample is flowing through the surface, specific targets are captured from solution by the probes onto the surface and detection is performed by mean of an epi-fluorescence microscope. The use of an FTC brings several improvements to the method described above such as the use of a porous membrane in order to permit the biological sample to contact the probes by flowing through the surface, optionally repeatedly via the use of a pumping system. This approach has the advantage to considerably fasten hybridization. However, this prior art method requires expensive and fragile inorganic membranes (wafers), such as micro-fabricated glass or porous silica. Furthermore this inorganic membrane requires derivatizing the glass surface with epoxysilane for attachment to said glass surface of an organonucleotide probe which has beforehand been modified by introducing a primary amine, and optionally one or more triethylene glycol units therebetween as spacer units, at one terminus thereof. These limitations result in a considerable increase in the cost involved for performing a microarray assay.

On the other hand, a technology requiring the activation or functionalization of a porous organic polymer membrane involves additional costs in terms of the preparation and quality control of materials.

There is therefore a need in the art for an improved, more simple and less expensive method to perform a microarray technique.

As used herein, and unless stated otherwise, the term “type”, when applied to a target biological compound, designates a group of compounds which are related by their molecular structure. Exemplary types of target biological compounds involved in the present invention include, but are not limited to, DNA biological compounds, RNA biological compounds, polypeptides, enzymes, proteins, antibodies and the like.

As used herein, and unless stated otherwise, the term “microarray assay” designates an assay wherein a sample, preferably a biological fluid sample (optionally containing minor amounts of solid or colloid particles suspended therein), containing target biological compounds is contacted with (e.g. passed through) a membrane (e.g. a membrane), containing a multiplicity of discrete and isolated regions across a surface thereof, each of said regions having one kind of probe applied thereto (e.g. by spotting), and each of said one kind of probe being chosen for its ability to bind with some specificity, preferably a specificity under stringent conditions, preferably a specificity under highly stringent conditions, to a maximum of one target biological compound per type of biological compound. As is well known to the skilled person, the stringency of binding conditions involve a series of parameters such as temperature, ionic concentration and pH.

As used herein, and unless stated otherwise, the term “target” designates a biological molecular compound fixed as goal or point of analysis. It includes molecular compounds such as but not limited to nucleic acids and related compounds (e.g. DNAs, RNAs, oligonucleotides or analogs thereof, PCR products, genomic DNA, bacterial artificial chromosomes, plasmids and the likes), proteins and related compounds (e.g. polypeptides, monoclonal antibodies, receptors, transcription factors, and the likes), antigens, ligands, haptens, carbohydrates and related compounds (e.g. polysacharides, oligosacharides and the likes), cellular organelles, intact cells, and the likes.

As used herein, and unless stated otherwise, the term “probe” designates a biological agent which is capable of being immobilized onto the surface of an organic polymer membrane and/or into said membrane, and which is able to interact specifically with a “target” (such as defined herein-above) that is part of the biological sample and which is used in order to detect the presence of said specific target. Suitable examples of such biological agents include molecular compounds such as, but not limited to, nucleic acids and related compounds (e.g. DNAs, RNAs, oligonucleotides or analogues thereof, PCR products, genomic DNA, bacterial artificial chromosomes, plasmids and the like), proteins and related compounds (e.g. polypeptides, monoclonal antibodies, receptors, transcription factors, and the like), antigens, ligands, haptens, carbohydrates and related compounds (e.g. polysacharides, oligosacharides and the like), cellular organelles, intact cells, and the like.

As used herein, and unless stated otherwise, the term “label” designates an agent which is detectable with respect to its physical distribution or/and the intensity of the signal it delivers, such as but not limited to luminescent molecules (e.g. fluorescent agents, phosphorescent agents, chemiluminescent agents, bioluminescent agents and the like), coloured molecules, molecules producing colours upon reaction, enzymes, magnetic beads, radioisotopes, specifically bindable ligands, microbubbles detectable by sonic resonance and the like.

As used herein, and unless stated otherwise, the term “tag” designates the action to incorporate a label into a probe.

Broadly speaking, the invention is based on the unexpected finding that a porous organic polymer membrane needs no activation or functionalization, provided that the unspotted areas of said membrane are blocked during the performance of the method, preferably before forcing the sample fluid through the pores of said membrane. In particular, this invention relates in a first aspect to a method for performing the analysis of a biological sample containing one or more target molecules. This method comprises the steps of:

a) applying a non-activated porous organic polymer membrane with probes in the form of an array of probe locations,
b) blocking areas remaining free of probes of said non-activated porous organic polymer membrane with one or more blocking substances, and
c) forcing the sample fluid repeatedly in one or two directions through the pores of said non-activated porous organic polymer membrane.

This invention also relates in a second aspect to a sensor suitable for said method, said sensor comprising:

a chamber comprising a non-activated porous organic polymer membrane, means for introducing a sample fluid containing one or more target molecules into said chamber, and

means for circulating said sample fluid repeatedly through said non-activated porous organic polymer membrane.

By performing this method of the invention, fast and highly specific measurement of target molecular compounds can be achieved without having recourse to expensive microfabricated inorganic membrane or performing functionalization or activation of an organic polymer membrane.

These and other aspects of the invention will be apparent from and elucidated with reference to the embodiment (s) described hereinafter.

In its broader acceptation, the present invention relates to a method for preparing and using a sensor for analysis of a sample fluid containing one or more target molecules, wherein said method comprises:

d) applying a non-activated porous organic polymer membrane with probes in the form of an array of probe locations,
e) blocking areas remaining free of probes of said non-activated porous organic polymer membrane with one or more blocking substances, and
f) forcing the sample fluid repeatedly in one or two directions through the pores of said non-activated porous organic polymer membrane.

The method of the present invention is especially useful when the one or more target molecules present in the sample, preferably the fluid sample, to be analyzed are molecules such as but not limited to, the following:

oligopeptides having from about 5 amino-acid units to 50 amino-acid units,

polypeptides having more than 50 amino-acid units,

proteins including enzymes,

oligo- and polynucleotides,

antibodies, or fragments thereof,

RNA, and

DNA.

For certain target molecules, a denaturation step may be beneficial, e.g. double stranded DNA can be separated into single strands in order to allow specific binding of the single strands to the capture probes spotted on the membrane. Such a denaturation step can be implemented in a convenient manner for instance by heating up either the membrane (wafer or membrane) or the sample, or both. When the sample is heated in such a denaturation step, an optional cooling step may be performed in order to keep the strands separated. The labels used in order to tag said one or more target biological compounds in a first step of the method, and ultimately permit their detection in a last step of the method, can be of luminescent (e.g. fluorescent, phosphorescent, or chemioluminescent), radioactive, enzymatic, calorimetric, sonic (e.g. resonance of micro-bubbles) or magnetic nature, or microbubbles. Specifically bondable ligands can be used in place of a label. In this last case, the ligand will be bound in a next step with a compatible label bearing agent.

Suitable fluorescent or phosphorescent labels include for instance, but are not limited to, fluoresceins, Cy3, Cy5 and the like.

Suitable chemioluminescent labels are for instance but are not limited to luminol, cyalume and the like.

Suitable radioactive labels are for instance but are not limited to isotopes like ¹²⁵I or ³²P.

Suitable enzymatic labels are for instance but are not limited to horseradish peroxidase, beta-galactosidase, luciferase, alkaline phosphatase and the like.

Suitable calorimetric labels are for instance but are not limited to colloidal gold and the like.

Suitable sonic labels are for instance but are not limited to microbubbles and the like.

Suitable magnetic beads are for instance but are not limited to Dynabeads and the like.

Each said one or more target molecules can be tagged with up to about 300 identical labels (during an eventual PCR amplification step for instance) in order to increase sensibility. As an optional step, unbound labels not incorporated into the target molecule and still present in the sample fluid may be removed from the sample fluid by means of chemical and/or physical treatments (e.g. chemical PCR purification, dialysis or reverse osmosis) in order to reduce the background signal during later measurements.

The sample fluid can be from industrial or natural origin. Examples of sample fluids suitable for performing the method of this invention may be, but are not limited to, body fluids such as sputum, blood, urine, saliva, faeces or plasma from any animal, including mammals (especially human beings), birds and fish. Other non-limiting examples include fluids containing biological material from plants, nematodes, bacteria and the like. The only requirement for a suitable performance of the method of this invention is that said biological material is present in a substantially fluid, preferably liquid form, for instance in solution in a suitable dissolution medium. The volume of the sample fluid to be used in the method of this invention can take any value between about 5 μl and 1 ml, preferably between about 50 μl and 400 μl.

In many cases, it is desirable to incorporate a buffer (e.g. a hybridization buffer) either directly into the sample fluid to be analyzed or as an integral part of the detection unit (e.g. added as a fluid or in lyophilized form either above or below the membrane), thus eliminating the need for a separate hybridization buffer storage area.

The porous organic polymer membrane present in the test chamber of the sensor of this invention has an upper surface and a lower surface. Said membrane is porous in order to permit the sample fluid to be forced through said membrane from the upper surface to the lower surface and/or from the lower surface to the upper surface.

The porous organic polymer membrane used in the present invention may be any non-activated porous polymer membrane. By non-activated porous organic polymer membrane, it is meant a porous organic polymer membrane that has not been chemically or physically treated to change its intrinsic affinity for biological molecules. The porous organic polymer membrane may include a network having a plurality of pores, openings and/or channels of various geometries and dimensions. The organic polymer membrane may be nanoporous or microporous, i.e. the average size of the pores, openings and/or channels may suitably be comprised between 0.05 μm and 10.0 μm, preferentially between 0.1 μm and 1.0 μm, more preferentially between 0.3 and 0.6 μm. The pore size distribution may be substantially uniform or it may have a polydispersity from about 1.1 to about 4.0, depending upon the manufacturing technology of said organic polymer membrane. The surface corresponding to the pores, openings or channels may represent between about 1 and 99%, preferably from about 10% to 90%, and more preferably from about 20% to 80%, of the total surface of either the upper surface or the lower surface of the porous membrane.

The thickness of the organic polymer membrane is not a limiting feature of this invention and it can vary from about 10 μm to 1 mm, preferably from 50 μm to 400 μm, more preferably from 70 μm to 200 μm. The shape of the organic polymer membrane is not a limiting feature of the present invention. It may be circular, e.g. with a diameter ranging between about 3 and 15 mm, but the method of the present invention can also be applied to any other membrane shape and/or size.

The porous organic polymer membrane onto which the probes are applied (e.g. spotted) is not a limiting feature of this invention and therefore can be made of any material already described in the art as a suitable membrane for biomolecule immobilization on porous membrane. Non-limitative examples of such materials typically include:

organic polymers such as polyamide homopolymers or copolymers (e.g. nylon), thermoplastic fluorinated polymers (e.g. PVDF), polyvinylhalides, polysulfones, cellulosic materials such as nitrocellulose or cellulose acetate, polyolefins or polyacrylamides and

inorganic materials such as glass, quartz, silica, other silicon-containing ceramic materials, metal oxide materials such as aluminium oxides, and the like.

The probes used for the present invention should be suitably chosen for their affinity to the target biological compounds or their affinity to relevant modifications of said target biological compounds. For example, if the target biological compounds are DNA, the probes can be, but are not limited to, synthetic oligonucleotides, analogues thereof, or specific antibodies. A non-limiting example of a suitable modification of a target biological compound is a biotin substituted target biological compound, in which case the probe may bear an avidin functionality.

In a preferred embodiment of the present invention, more than one different probes are applied on the membrane and in a even more preferred embodiment, multiple different probes are spotted in an array fashion on physically distinct locations along one surface of said membrane in order to allow measurement of different targets in parallel.

In order to more easily support subsequent detection and identification, one or more additional spots (e.g. for intensity calibration and/or position detection) can be spotted as well onto the surface of the membrane.

Following spotting, the probes become immobilized onto the surface of the membrane, either spontaneously due to the membrane (e.g. membrane) inherent or acquired (e.g. via activation) properties, or through an additional physical treatment step (such as, but not limited to, cross-linking, e.g. through drying, heating or through exposure to a light source).

In order to improve the shelf-live of the membrane (e.g. membrane) and the probes attached thereon, drying the membrane when the membrane is not in use may be helpful. The membrane is thereafter rehydrated in contact with the sample fluid.

Once the probes are applied (e.g. via ink-jet spotting) onto a surface of the membrane, the addition of an effective amount of a blocking agent in order to inactivate the non-spotted areas of the membrane may be helpful to prevent unspecific binding of target biological compounds or unbound labels to unspotted areas (that would lead to unwanted background signal) and to therefore increase to signal/noise ratio. Examples of suitable blocking substances or agents include, but are not limited to, salmon sperm, skim milk, or polyanions in general.

In another embodiment of the present invention, different labels can be used simultaneously to simultaneously measure:

i) one or more target molecules from different sample fluids (e.g. different sample fluids like blood and sputum or different sample fluids originating from different locations), or
ii) differential expression of analytes from multiple sample fluids (e.g. treated vs. untreated, diseased vs. diseased, etc. . . . ), or
iii) different types of target molecules from the same sample fluid (e.g. analysis of a blood sample fluid for its DNA and RNA content).

During the actual sensing step, the biological sample is forced through the membrane surface. This can be achieved by pumping the fluid through said surface and/or by moving the porous membrane through said biological sample. In this later case, the movement of the porous membrane during the forcing of the biological sample through said porous membrane is preferably performed in a direction perpendicular to the surface of said porous membrane. In order to increase sensitivity and specificity, the aforementioned pumping or membrane movement step can then be repeated either at the same or at a different temperatures.

The pumping through, and/or movement of, the porous membrane can either be unidirectional or bi-directional. With each pumping step or each movement of the porous membrane, new target molecules have the chance to bind to the spotted capture probes.

Quantitatively measuring the presence of labels after a predetermined number of pumping steps and/or membrane moving steps or cycles, e.g. after each pumping and/or membrane moving step or cycle, may be useful. The results of such quantitative measurements, in combination with the knowledge of the actual membrane and/or sample fluid temperature, permits to determine some of the kinetic properties of the target biological compounds. Heating the sample fluid to a defined temperature allows, through imparting more stringent binding conditions, a more precise control of the binding properties, especially binding specificity. This heating step can also be achieved by heating either the membrane or the sample fluid or both. After the desired temperature has been reached, the sample fluid is then contacted with the membrane.

Sensitivity of the method and/or binding specificity can also be increased by one or more suitable means such as, but not limited to:

using appropriate temperature profiles (e.g. a series of one or more heating steps optionally with adequate equilibration times between consecutive heating steps),

adapting the number of membrane moving cycles, and

signal post-processing of the measured label signals (e.g. image processing of fluorescence image) for a measurement series, and

determining the temperatures at which the captured target biological compounds bind optimally or separate again.

For example, when increasing the temperature, a sharp decrease of the measured signal will indicate that the separation (melting) temperature of a given capture probe-target biological compound complex has been reached. This property can be used to distinguish between specific and unspecific binding. To even further improve specificity, the measurement cycle can the be continued after exceeding the melting temperature threshold, this time with continuously decreasing temperatures in order to confirm that re-binding of the target biological compounds occurs again below appropriate specific melting temperature.

An optional final step of the method consists then in removing residual sample fluid from the detection chamber in order to further decrease the background signal due to unbound labels and/or molecules.

The detection chamber geometry is preferably designed in such a way that unbound labels and/or molecules are shielded from the detection system during measurement, e.g. (in the case of labels being luminescent molecules) through obstruction of the optical path for the light emitted from the sample fluid below the membrane or by moving the membrane close to the optically transparent window and thereby chasing away the supernatant. The background signal can be further reduced by whipping the supernatant by a built-in whipper. The removal of the sample fluid as well as the design of the detection chamber geometry ensure that the membrane surface facing the detection system as well as the opposite side of the membrane have a minimal amount of sample fluid as surface layers. This reduces the background signal from unbound labels and/or unbound molecules.

After a suitable contact time of the membrane with the sample fluid, e.g. after a suitable of pumping/membrane moving cycles, the labels of the target biological compounds bound to the probes are detected and measured. Additionally, the labels may also be measured during the movement of the membrane.

The physical location, the nature and the intensity of each signal observed permits to identify which target biological compound has been captured, to identify from which sample this target biological compound originates and/or to which type(s) of biological compound it belongs and to assess its concentration.

Analysis of the membrane in the final step of the method of the invention may be performed via an optical set-up comprising an epi-fluorescence microscope and a CCD (charged coupled device) camera or any other kind of camera. This optical set-up preferably comprises a (preferably UV) light source capable of exciting the labels at their respective excitation wavelength, in the case of fluorescent or phosphorescent labels.

The detection of chemioluminescent labels may be for instance performed by adding an appropriate reactant to the label and observing its fluorescence via the use of a microscope.

The detection of radioactive labels may be for instance performed by the placement of medical X-ray film directly against the membrane which develops as it is exposed to the label and creates dark regions which correspond to the emplacement of the probes of interest.

The detection of enzymatic labels may be for instance performed by adding an appropriate membrane to the label and observing the result of the reaction (e.g. colour change) catalyzed by the enzyme.

The detection of colorimetric labels may be for instance performed by adding an appropriate reactant to the label and observing the resulting appearance or change of colour.

The detection of sonic microbubble labels may be for instance performed by exposing said labels to sound waves of particular frequencies and recording the resulting resonance.

The detection of magnetic beads may be for instance performed by magnetic sensor(s).

The method of the present invention has been described herein above by reference to a significant number of parameters, each of them including the possible selection of preferred, or even more preferred, values or embodiments. It should be understood that, unless explained otherwise with respect to certain combination of parameters, each preferred range or embodiment for one such parameter may be combined at will with each preferred range or embodiment for one or more other parameters.

This invention will now be described with respect to certain working embodiments explained in the following example and with reference to the appended figures. This example however is merely illustrative of the invention and should not be construed as limiting the invention in any way.

### EXAMPLE

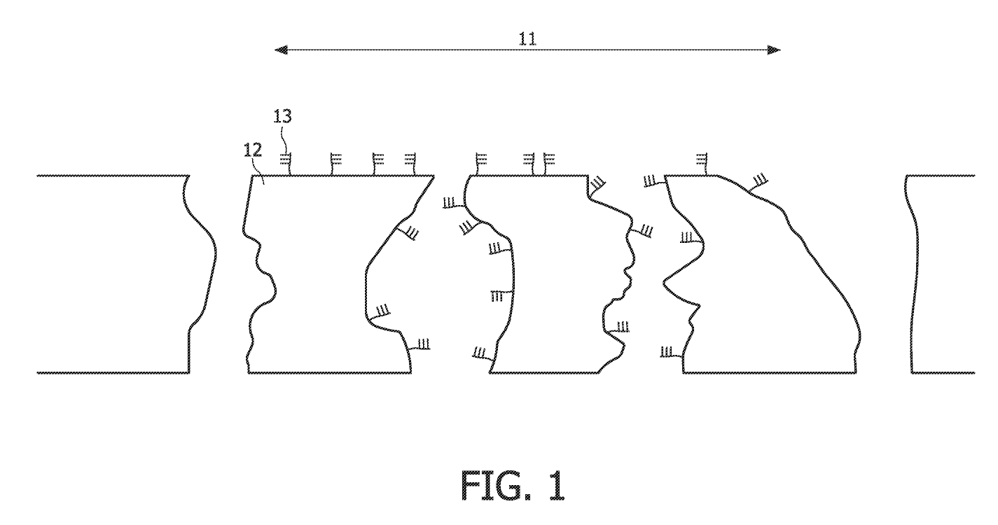

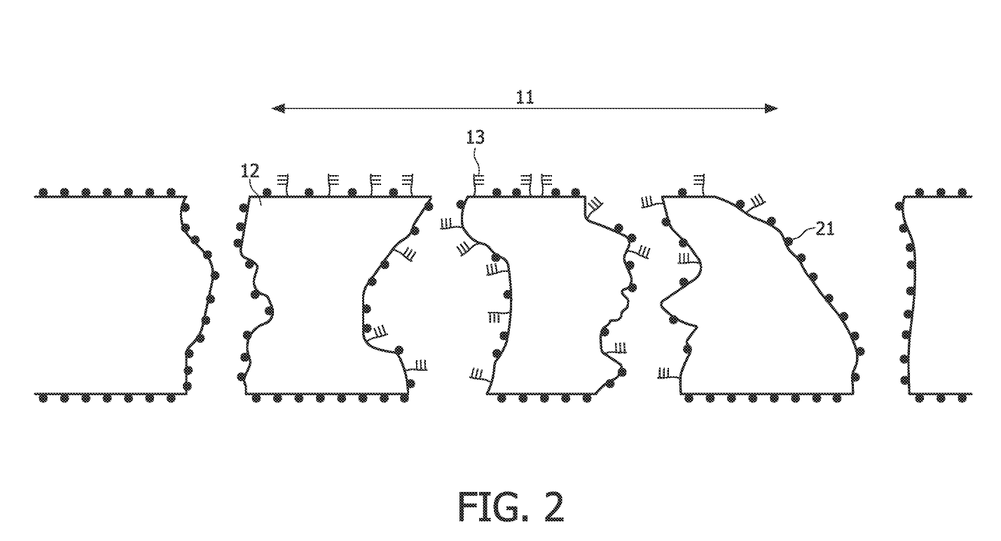

A working embodiment of the present invention is described in FIGS. 1, 2,3 and 4. FIG. 1 shows the scheme of a porous polymer membrane (12) whereon probes (13) are applied on a specific location (11) thereof. FIG. 2 shows the scheme of the blocking, by addition of blocking substances (21), of the area of membrane (12) remaining free of probes (13).

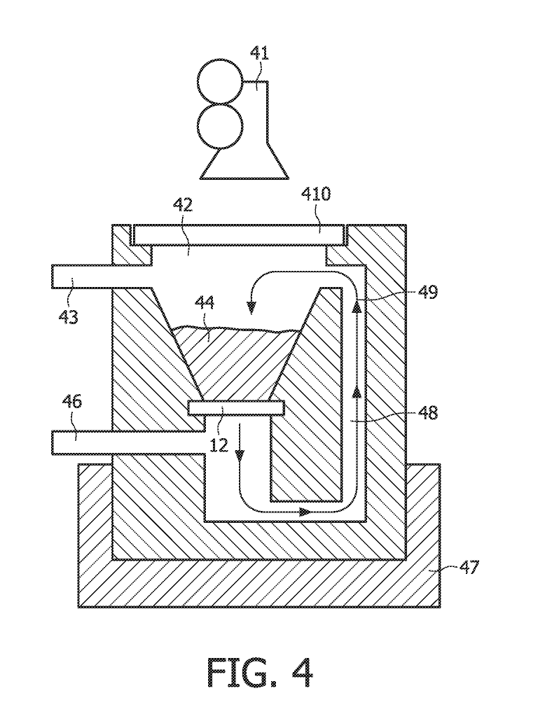

FIG. 4 presents a scheme of a particular set-up usable in the method of the present invention. In this scheme, a sample fluid (44) at a temperature controlled by the heater (47) is represented in a chamber (42) and a pressure is applied at the inlet (43) while a one-way valve (49) is closed. This pressure forces the sample fluid (44) downwards through the porous membrane (12).

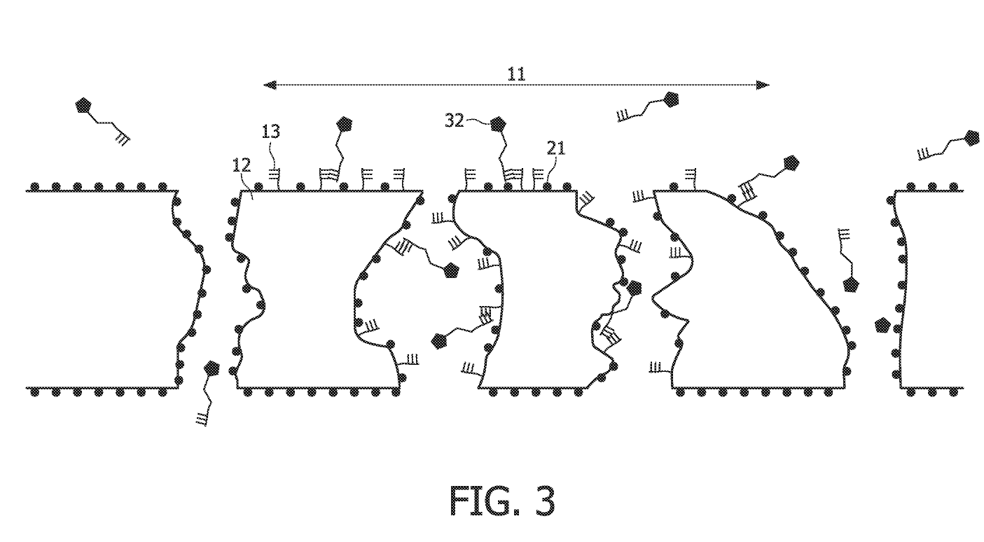

FIG. 3 shows the scheme of the then occurring binding of target molecules (32) to probes (13) presents within the specific location (11) and the non-binding of target molecules (32) within the blocked area of the membrane (12). FIG. 4 shows that an analysis of the porous membrane (12) is done at this step by the detection system (41). The application of a pressure at the inlet (46) transports the sample fluid along the by-pass (48) through the then-open one-way valve (49) to bring the sample fluid (44) back into the chamber (42). The whole process can be repeated several times.

1. A method for preparing and using a sensor for the analysis of a sample fluid containing one or more target molecules, wherein said method comprises:
(a) applying a non-activated porous organic polymer membrane with probes in the form of an array of probe locations, said probes being able to specifically bind to said one or more target molecules,
(b) blocking areas remaining free of probes of said porous organic polymer membrane with one or more blocking substances and
(c) forcing the sample fluid repeatedly in one or two directions through the pores of said porous organic polymer membrane.

2. A method according to claim 1, wherein said non-activated porous organic polymer membrane comprises a polyamide homopolymer or copolymer.

3. A method according to claim 1, wherein said non-activated porous organic polymer membrane comprises a thermoplastic fluorinated polymer.

4. A method according to claim 1, wherein said non-activated porous organic polymer membrane comprises a cellulosic material.

5. A method according to claim 1, wherein said non-activated porous organic polymer membrane is dried after step (a) and/or after step (b).

6. A method according to claim 1, wherein said forcing of the sample fluid through the pores of said non-activated porous organic polymer membrane is performed by way of pumping.

7. A method according to claim 6, wherein said pumping is performed repeatedly in one direction only.

8. A method according to claim 1, wherein the sample fluid is forced through the membrane by moving the membrane through the sample fluid.

9. A method according to claim 1, wherein said one or more target molecules are labeled with one or more detectable labels.

10. A method according to claim 9, wherein said labels are selected from the group of luminescent labels, enzymatic labels, magnetic labels, radioactive labels and microbubbles.

11. A method according to claim 1, further comprising analysing said non-activated porous organic polymer membrane so as to determine the presence and/or concentration of said one or more target molecules.

12. A sensor comprising:
a chamber comprising a non-activated porous organic polymer membrane,
means for introducing a sample fluid containing one or more target molecules into said chamber, and
means for circulating said sample fluid repeatedly through said non-activated porous organic polymer membrane.

13. A sensor according to claim 12, wherein said non-activated porous organic polymer membrane comprises a polyamide homopolymer or copolymer.

14. A sensor according to claim 12, wherein said non-activated porous organic polymer membrane comprises a thermoplastic fluorinated polymer.

15. A sensor according to claim 12, wherein said non-activated porous organic polymer membrane comprises a cellulosic material.

16. A sensor according to 12, further comprising means for analysing said non-activated porous organic polymer membrane so as to determine the presence and/or concentration of said one or more target molecules.

17. A sensor according to claim 12 wherein the membrane comprises an array of probe locations, and areas remaining free of probes are blocked with one or more blocking substances.
